(19) United States
(12) Patent Application Publication
(10) Pub. No.: US 2008/0187391 A1
(43) Pub. Date: Aug. 7, 2008

(54) AUTOMATION ADJUSTMENT UTILIZING LOW MELTING POINT ALLOYS

(75) Inventor: VICTOR B. MIMKEN, Boise, ID (US)

Correspondence Address: PATTERSON & SHERIDAN, LLP - - APPM/TX, 3040 POST OAK BOULEVARD, SUITE 1500, HOUSTON, TX, 77056, US

(73) Assignee: APPLIED MATERIALS, INC.

(21) Appl. No.: 11/670,204

(22) Filed: Feb. 1, 2007

(51) Int. Cl. F16B 1/00

(52) U.S. Cl. 403/28

(57) ABSTRACT

A method and apparatus for adjusting or aligning two or more parts, elements, devices, or structures coupled together by an adjustable interface is described. The apparatus includes an adjustable joint at the interface, which includes a housing adapted to receive a portion of one of the two or more parts. The housing also includes a filler that is cycled between a liquid state and a solid state to facilitate adjustment and rigidity, respectively, between the portion of the two or more parts and the housing. The housing may include integral heating members to heat the filler. The method includes heating the filler to facilitate adjustment, adjusting the portion of the two or more parts, and cooling the filler.

### BACKGROUND OF THE INVENTION

1. Field of the Invention

Embodiments of the present invention generally relate to a method and apparatus to facilitate adjustment or alignment of a joint or interface between two pieces of equipment, components, or portions of two pieces of equipment, parts, or components. More specifically, embodiments described herein relate to a filler material in the joint or interface to facilitate adjustment.

2. Description of the Related Art

Automated and non-automated equipment generally comprise a plurality of structural members, parts, or components coupled together to form a structure or framework suited for a particular use. The structure or framework may be configured to hold a part relative to a machine or tool, such as a jig or fixture, or the structure or framework may be configured to transfer a workpiece from on location to another, such as a pick-and-place device, among other workpiece transfer devices. Other equipment may include a structure or framework configured to support another structure, part, device, or mechanism.

FIG. 1 is an example of a transfer mechanism 100 configured to support and transfer a workpiece 140, which may be a semiconductor substrate or wafer. The transfer mechanism 100 may be part of a substrate surface cleaning/substrate surface preparation device that is configured to transfer and raise and lower the substrate relative to a surface cleaning/surface preparation chamber (not shown). Examples of a substrate surface cleaning/substrate surface preparation device and chamber may be found in U.S. patent application Ser. No. 11/460,049, filed Jul. 26, 2006, in the description of FIGS. 7-10 in U.S. patent application Ser. No. 10/941,600, filed Sep. 15, 2004, and in the description of FIGS. 7B-7D in U.S. Pat. No. 6,726,848, filed Dec. 7, 2001 and issued on Apr. 27, 2004. A system level description and platform for a substrate surface cleaning/substrate surface preparation tool and associated chambers may be found in U.S. patent application Ser. No. 11/620,610, to Lester, et al., filed Jan. 5, 2007.

The mechanism 100 generally includes a transfer means 105 coupled in a cantilevered fashion to a translational means 110, such as an actuation device or robotic device configured to move the transfer means 105 linearly and/or rotationally in the X, Y, and Z directions. The translational means 110 may be coupled to a base 129 to provide rigidity to the translational means 110 and stability to the transfer means 105 coupled thereto. The transfer means 105 includes a support member 115 and rod members 118 coupled thereto, which may include end effectors 120 configured to receive and support the workpiece 140. The transfer means 105 also includes a connecting member 125 coupled to the support member 115 that is adjustably coupled to a junction 140 at a joint, which is generally indicated at 150. The junction 140 may be a sleeve, a tubular member, a bracket, and the like, and may be coupled to an extended member 130 disposed on the translational means 110. In this example, the extended member 130 moves relative to a body 126 of the translational means 110 to facilitate moving the joint 150 and the transfer means 105 relative to the translational means 110 at least in the Z axis. For example, the extended member 130 may be coupled to an actuator within the body 126 of the translational means, such as a lead screw, and moves at least in the Z direction relative to the body 126.

The transfer means 105 typically includes couplings 112A-112D, such as coupling 112C and 112D between members 115 and 118, coupling 112B between member 115 and the connecting member 125, and coupling 112A between the junction 140 and the translational means 110. The couplings 112A-112D are typically a static coupling configured to prevent or minimize movement between the respective parts, and is typically designed and configured to maintain rigidity and position of the respective parts, as the respective parts may not require frequent or foreseeable adjustment. The couplings 112A-112D may be formed by a bond, for example, by welding, brazing, an adhesive, or other bond, which make movement between the respective parts difficult, if not impossible, without extensive downtime. Threaded connections and fasteners, such as bolts, screws, rivets, and the like may also be used to form the couplings 112A-112D.

The interface between the transfer means 105 and the translational means 110, which includes the joint 150, is configured to allow adjustment of the transfer means 105 relative to the translational means 110. Specifically, the connecting member 125 may selectively move in at least a portion of the six degrees of freedom, as shown in the inset at FIG. 1, relative to the junction 140, thus allowing adjustment and orientation of the transfer means 105, which is coupled thereto. The interior volume of the junction 140 may be sized slightly larger than the outer dimension of the connecting member 125 to allow this movement. The junction 140 may generally include one or more adjustment members 135, such as bolts and screws, for example set screws and/or jacking screws, which may be loosened to allow movement of the connecting member 125 relative to the junction 140. The junction 140 may comprise two or more adjustment members 135 that are typically disposed orthogonally to each other and more commonly, the junction 140 may comprise a group or set of adjustment members 135, and one group is typically disposed orthogonally to another set. Shims and the like may also be used to adjust the orientation of the connecting member 125 with or without the use of the adjustment members 135.

The adjustment of the transfer means 105 may be accomplished by systematic loosening and tightening of the adjustment members 135, which is often a time-consuming task. However, during adjustment of the transfer means 105, tightening or loosening of one or more of the adjustment members 135 may often alter a previous adjustment. For example, tightening of one or more adjustment member(s) 135 may require loosening of one or more of the other adjustment member(s) 135, which may cause the orientation of the transfer means 105 to be altered or misaligned from the previous or desired adjustment. Therefore, the adjustment of the transfer means 105 to be statically positioned in the desired orientation may require multiple adjustments to, and manipulation of, the adjustment members 135, which may result in extensive downtime of the equipment as personnel tighten and loosen the adjustment members 135. Further, the transfer mechanism 100 or other equipment may be disposed in a housing or adjacent another structure that may make the junction 140 or joint 125 difficult to access by personnel. For example, the housing or other structure may have to be partially disassembled or moved to provide access to the junction 140, which may extend downtime of the equipment.

Therefore, there is a need for an adjustable joint that minimizes equipment downtime and facilitates easy adjustment by personnel.

### SUMMARY OF THE INVENTION

The present invention generally describes a method and apparatus for adjusting or aligning two or more parts, elements, devices, or structures coupled together by an adjustable interface is described. The apparatus includes an adjustable joint at the interface, which includes a housing adapted to receive a portion of one of the two or more parts. The housing also includes a filler that is cycled between a liquid state and a solid state to facilitate adjustment and rigidity, respectively, between the portion of the two or more parts and the housing. The housing may include integral heating members to heat the filler. The method includes heating the filler to facilitate adjustment, adjusting the portion of the two or more parts, and cooling the filler.

In one embodiment, an adjustable joint is described. The adjustable joint includes a housing having an interior volume configured to receive at least a portion of a shaft, a heating means coupled to and in communication with at least a portion of the housing, and a eutectic filler material disposed in the housing that is cycled between a solid state and a liquid state, wherein the filler material has a melt-point range between about 110° F. and about 160° F.

In another embodiment, an adjustable interface between two or more structural components disposed on a piece of equipment is described. The adjustable interface includes a shaft coupled to at least one of the structural components, a housing having an interior volume configured to receive at least a portion of the shaft, the interior volume sized to permit axial, radial, rotational, and longitudinal movement to the shaft, a filler material disposed in the interior volume and in contact with the portion of the shaft disposed in the interior volume, and a flexible retention member coupled to a portion of the housing and the shaft, wherein the housing is configured to provide heat to the filler material.

In another embodiment, a method for adjusting an interface between two or more structural components disposed on a piece of equipment is described. The method includes providing a housing at the interface having an interior volume configured to receive at least a portion of one of the two or more structural components, wherein the structural component is in communication with a solid filler material disposed in the housing, heating the solid filler material to at or near a melt-point, adjusting the structural component in one or more of the six degrees of freedom, and cooling the filler material below the melt-point.

In another embodiment, a method for adjusting an interface between a first and second structural component is described. The method includes providing a housing at the interface having an interior volume configured to receive at least a portion of the first structural component and having a metallic filler material disposed therein, and cycling the metallic filler material between a liquid state and a solid state, wherein the first structural component may be moved relative to the second structural component when the filler is in a viscid, semi-viscid, or liquid state, and wherein the first structural component is fixed relative to the second structural component when the filler is in a solid state.

### BRIEF DESCRIPTION OF THE DRAWINGS

So that the manner in which the above recited features of the present invention can be understood in detail, a more particular description of the invention, briefly summarized above, may be had by reference to embodiments, some of which are illustrated in the appended drawings. It is to be noted, however, that the appended drawings illustrate only typical embodiments of this invention and are therefore not to be considered limiting of its scope, for the invention may admit to other equally effective embodiments.

FIG. 1 is a schematic view of one embodiment of a transfer mechanism according to the prior art.

FIG. 2 is a schematic view of one embodiment of a transfer mechanism of the present invention.

FIG. 3A is a cross sectional view of one embodiment of an adjustable joint.

FIG. 3B is a cross-sectional view of the adjustable joint shown in FIG. 3A, rotated 90 degrees.

FIG. 4 is a cross-sectional view of another embodiment of an adjustable joint.

FIG. 5 is a schematic view of one embodiment of a holding means coupled to a transfer mechanism.

To facilitate understanding, identical reference numerals have been used, wherever possible, to designate identical elements that are common to the figures. It is also contemplated that elements disclosed in one embodiment may be beneficially utilized on other embodiments without specific recitation.

### DETAILED DESCRIPTION

The present invention describes a method and apparatus for an adjustable joint or adjustable interface on a piece of equipment between two parts, structures, components, or elements that may move or require adjustment relative to each other. Embodiments described herein may be exemplarily described in reference to automated equipment, specifically a mechanism configured to support and transfer a semiconductor substrate, but the invention may be used on other equipment, parts, components, and devices as well. Examples include jigs, workpiece holding devices, and the like. Other examples include any equipment or components thereof having two or more parts or elements that may require periodic adjustment and/or alignment relative to each other, or one or more parts or elements that may require periodic adjustment and/or alignment relative to a workpiece.

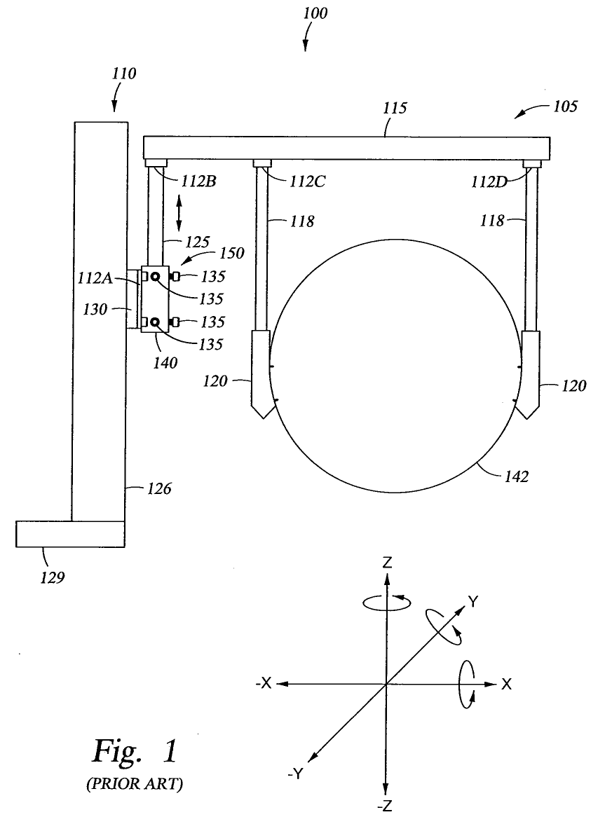

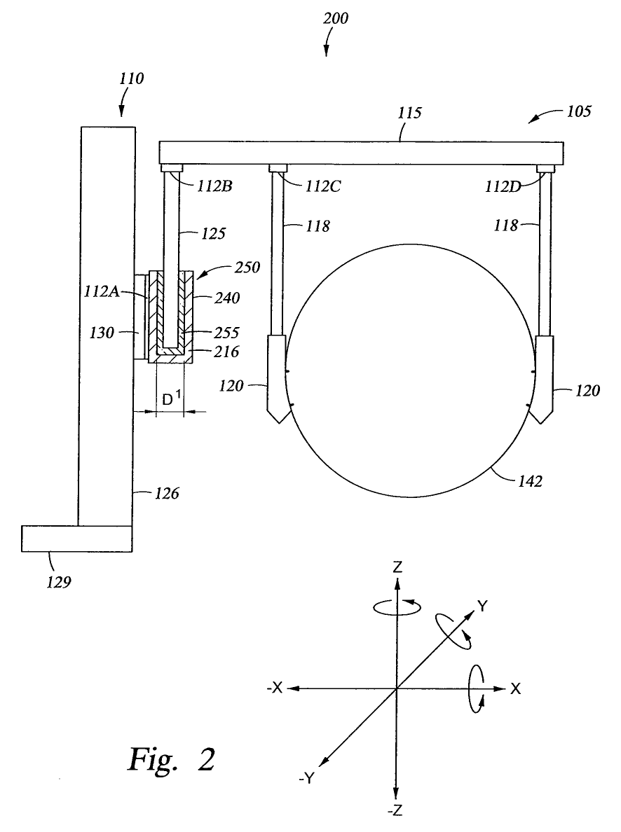

FIG. 2 is a schematic view of one embodiment of a transfer mechanism 200 configured to support and transfer a workpiece 140 to and from a chamber (not shown), which may be part of a substrate surface cleaning/substrate surface preparation device similar to the transfer mechanism of FIG. 1. Examples of a substrate surface cleaning/substrate surface preparation device and an associated cleaning and drying chamber may be found in the description of FIGS. 9 and 10 of U.S. patent application Ser. No. 11/460,049, filed Jul. 26, 2006, and in the description of FIG. 1 of U.S. patent application Ser. No. 11/460,054, filed Jul. 26, 2006, both of which are incorporated by reference in their entireties. Other chambers and associated transfer mechanisms may be found in the description of FIGS. 7B-7D of U.S. Pat. No. 6,726,848, filed Dec. 7, 2001, which issued on Apr. 27, 2004. A system level description and platform for a substrate surface cleaning/substrate surface preparation device associated chambers, support systems, and other devices may be found in U.S. patent application Ser. No. 11/620,610, to Lester, et al., filed Jan. 5, 2007.

The mechanism 200 generally includes a first structural component, such as a transfer means 105 coupled to a second structural component, such as a translational means 110. The translational means 110 may be an actuation device or robotic device configured to move the transfer means 105 linearly and/or rotationally in the X, Y, and Z directions similar to the transfer mechanism of FIG. 1. Like reference numerals are used to denote similar elements in FIGS. 1 and 2, and some elements will not be discussed in detail with reference to FIG. 2. In one embodiment, the extended member 130 is adapted to move relative to the body 126 of the translational means 110 in order to provide at least vertical movement to the transfer means 105, similar to the embodiment in FIG. 1.

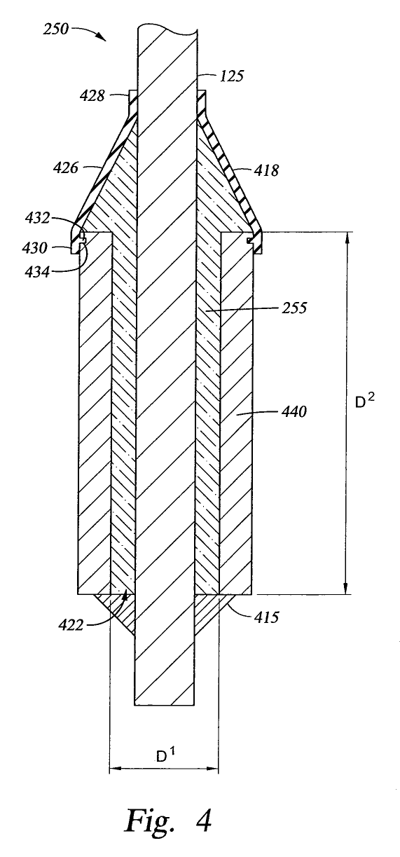

In this embodiment, the interface between translational means 110 and the transfer means 105 includes an adjustable joint 250, and the junction 140 of FIG. 1 is replaced with a joint housing 240. The joint housing 240 includes a filler 255 that is adapted to facilitate adjustment of the connecting member 125 by a phase change of the filler 255 between a solid and a liquid, for example between a solid state and a non-solid state, such as a viscid or semi-viscid state. The joint housing 240 may be a tubular member, a bracket, a cup-shaped member, and the like, which is adapted to at least partially contain a fluid and is resistant to elevated temperatures. Materials for the joint housing 240 may include heat-resistant materials, such as aluminum, copper, bronze, brass, steel, stainless steel, polymers, ceramics, and the like. Composite materials may also be used, such as carbon fiber epoxy blends, among others. Other materials for the joint housing 240 may include fabrics, plastics, and rubber materials that are adapted to contain the filler 255 in a solid, liquid, viscid, or semi-viscid state and are chosen to withstand temperature fluctuations to facilitate the phase change of the filler 255. The joint housing 240 may include a though-hole 422 as shown in FIG. 4, or may include a bottom 216 as shown in FIG. 2. The joint housing 240 may include an interior surface that includes a roughened coating or is otherwise adapted to include a roughened surface.

In this embodiment, the connecting member 125 may be a shaft, a rod, a bar, a rigid wire or cable, or other structural element. The connecting member 125 may include a cross-section that is circular, tubular, rectangular, triangular, “H” shaped, “I” shaped, among other cross-sections. The connecting member 125 may be made of a metallic material, a ceramic material, a polymer, or any other material that is resistant to temperature fluctuations enabling the phase change of the filler 255 and provides sufficient mechanical integrity to the device, component, or part coupled thereto.

Unlike the junction 140 in FIG. 1, which may include an interior volume sized slightly larger than the connecting member 125 to allow selective freedom of movement, the joint housing 240 may include an interior volume that is much greater than the interior volume of the junction 140. For example, the joint housing 240 may include a dimension D¹ that is greater than an outside area or outer dimension of the connecting member 125. For example, the connecting member 125 may be a rod having a circular cross-section and the dimension D¹ of a tubular-shaped joint housing 240 is greater than the outer diameter of the connecting member 125. The greater dimension D¹ of the joint housing 240 facilitates movement of the connecting member 125 in at least a portion of the six degrees of freedom, in order to permit adjustment and/or alignment of the transfer means 105 relative to the translational means 110. In one embodiment, the dimension D¹, which may be an inside diameter or an inside cross-sectional area, is between about 20% to about 300% greater than the outer dimension of the connecting member 125, such as about 50% to about 100% greater than the outer dimension of the connecting member 125. The dimension D¹ is adapted to provide enhanced torsional, radial, rotational, longitudinal, and axial movement to the connecting member 125 relative to the joint housing 240.

In this embodiment, the adjustable joint 250 includes the filler 255 that facilitates adjustment and/or alignment of the transfer means 105 relative to the translational means 110. The filler 255 is adapted to facilitate adjustment of the connecting member 125 by a phase change of the filler 255 between a solid and a liquid, for example between a solid state and a non-solid state, such as a viscid or semi-viscid state. The phase change to the viscid, semi-viscid, and/or liquid state may be provided by applying heat to the filler 255 and/or the joint housing 240. The phase change of the filler 255 permits movement of the connecting member 125 in a non-solid state, such as a liquid state and a viscid or semi-viscid state, and provides rigidity to the connecting member 125 in the solid state. The filler 255 may be a metal, such as an alloy, a polymer material, such as a thermoplastic, resins, or any material having a definitive melting point or melt-point range with sufficient mechanical properties suited for the particular application. In applications where the mechanical stress, or other mechanical properties and physical factors allow, the filler 255 may be a wax or wax composite, such as a blend of wax and reinforcing fibers, for example fiberglass fibers or carbon fibers, among others. In some embodiments, the filler 255 may be an electrorheological fluid or a magnetorheological fluid that may be cycled between varying degrees of viscosity to facilitate adjustment and/or alignment of the transfer means 105 relative to the translational means 110, and stability between the transfer means 105 and the translational means 110.

In one embodiment, the filler 255 is a eutectic mixture or eutectic alloy having a definitive transition temperature between a solid and liquid. Alternatively, the filler 255 may be a non-eutectic mixture or alloy having a transition temperature range between a solid and a liquid, and may include the viscid or semi-viscid state discussed above. In one embodiment, the filler 255 may have a melt-point or melt-point range higher than 212° F., such as between about 350° F. and below, such as between about 260° F. to about 240° F. In another embodiment, the filler 255 has a low melt-point or melt-point range, such as a melt-point or melt-point range below about 212° F., such as between about 180° F. and about 90° F., for example, between about 160° F. and about 115° F. In one specific embodiment, the filler 255 is a metal alloy having a melt-point of about 117° F., wherein the filler 255 is in a liquid state at 117° F. or greater and in a solid state at 116° F. or less. In another embodiment, the filler 255 is a metal alloy having a melt-point of about 136° F., wherein the filler 255 is in a liquid state at 136° F. or greater and in a solid state at 135° F. or less. In another embodiment, the filler 255 includes a melt-point or melt-point range between about 110° F. and about 160° F.

In one embodiment, the joint housing 240 and the connecting member 125 are typically made of a material that is significantly more heat-tolerant than the filler 255, wherein the material comprising the joint housing 240 and/or connecting member 125 may withstand temperatures between about 100° F. to about 500° F. higher than the melt-point or melt-point range of the filler 255 without affecting the integrity of the joint housing 240 and/or the connecting member 125. In some embodiments, the material comprising the joint housing 240 and/or connecting member 125 may withstand temperatures significantly greater than the melt-point or melt-point range of the filler 255 without affecting the integrity of the joint housing 240 and/or the connecting member 125.

The filler 255 may be chosen, in part, based on mechanical properties of the filler as well as mechanical and physical properties of the components adjacent to, or in thermal communication with, the filler 255 and/or the joint housing 240. For example, components, structures, devices, and the like, that are adjacent to, or in thermal communication with, the joint housing 240, may absorb thermal energy during the heating process and/or after the filler 255 is heated. The absorption of, or exposure to, heat may pose a safety hazard if the heat needed to cause the phase change of the filler exceeds a certain acceptable limit or range. Further, the absorption or exposure of heat may cause thermal expansion of parts or components near, or in thermal communication with, the joint housing 240. Therefore, the choice of filler 255 may depend on the amount of thermal energy required to cause the phase change due to the factors above. The thermal energy or heat may be provided by heating members as described below, but the heat may also be provided by a heated fluid flowed on or near the adjustable joint 250, a portable heating element, a flame, radiation, light, or any other form of energy.

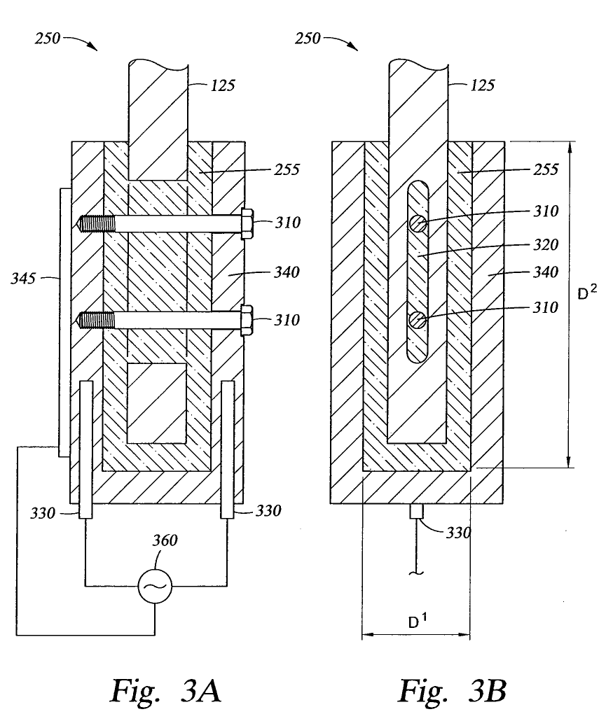

FIG. 3A is a cross sectional view of one embodiment of an adjustable joint 250. The adjustable joint 250 includes a connecting member 125 at least partially disposed in a joint housing 340, which includes an integral heating means coupled thereto, such as one or more heating members 330 and one or more heating members 345 (only one is shown). The heating members 330, 345 are configured to supply sufficient energy to the joint housing 340 to melt the filler 255. The heating members 330 may be a resistive heating element, such as a cartridge heater or heating coils, and the heating member 345 may be a contact heating means, such as heating tape or heating coils adjacent the body of the joint housing 240, or wrapped at least partially around, or otherwise in contact with, the joint housing 240. The heating members 330, 345 are coupled to a power source 360, which may be coupled to a controller (not shown) to provide control of the heating members 330, 345. In some applications where intentional or accidental tampering is a concern, access to the power source 360 and/or the controller could be limited to specific personnel.

The adjustable joint 250 may also include one or more static members 310 coupled to the joint housing 340. The static members 310 may be included to provide additional shear strength to the connecting member 125, and may additionally function as a guide or limit for the connecting member 125, thus at least partially limiting movement of the connecting member 125 relative to the joint housing 340. Each of the static members 310 may be a rod or shaft substantially statically coupled to the joint housing 340, a fastener, such as a bolt, a screw, or combinations thereof.

FIG. 3B is a cross-sectional view of the adjustable joint 250 shown in FIG. 3A, which is rotated 90 degrees. The static members 310 may be disposed in a groove or channel 320 formed in the connecting member 125. Alternatively, the connecting member 125 may include one or more through-holes (not shown) adapted to receive the one or more static members 310. The channel 320 or the through-holes include a diameter or inside area greater than the diameter or cross-sectional area of the static members 310 to facilitate enhanced movement of the connecting member 125 within the joint housing 340 when the filler 255 is in a viscid, semi-viscid, or liquid state. Additionally, the channel 320 or through-holes provide a larger surface area for the filler 255, which may enhance coupling of the filler 255 and the connecting member 125, and may also enhance rigidity of the connecting member 125 when the filler 255 solidifies. In one embodiment, the connecting member 125 may include a roughened outer surface to facilitate enhanced coupling and rigidity of the connecting member 125 relative to the joint housing 340. The interior volume of the joint housing 340 may also be roughened to enhance coupling of the filler 255 to the joint housing 340.

As described in FIG. 2 with reference to the joint housing 240, the joint housing 340 also includes a dimension D¹ that may include an inside diameter or inside area of the joint housing 340. The joint housing 340 also includes a depth depicted as D², which may be a longitudinal dimension of the interior volume of the joint housing 340. Collectively, the dimension D¹ and the depth D² generally define an interior volume of the joint housing 340, which is at least partially filled with the filler 255.

FIG. 4 is a cross-sectional view of another embodiment of an adjustable joint 250. The adjustable joint 250 includes a joint housing 440 configured as a tubular member having a longitudinal passage 422 formed therethrough. The longitudinal passage 422 includes the filler 255 that may be in a viscid, a semi-viscid, a liquid, or solid state. In one embodiment, the joint housing 440 may be disposed in a horizontal orientation, disposed in a vertical orientation, or disposed in some angle between horizontal and vertical, to the mechanism 200 (FIG. 2). If the filler 255 is in a viscid, semi-viscid, or liquid state in these orientations, the filler 255 may succumb to gravitational forces and at least a portion of the filler 255 may flow out of the passage 422. To prevent or minimize the filler from flowing out of the joint 250, a retention member 415 and/or 418 may be coupled between the joint housing 440 and the connecting member 125.

The retention members 415, 418 are configured to act as a fluid seal for the filler 255 as well as minimizing splashing of the filler 255, and may be made of a flexible or compliant material resistant to temperatures encountered by the joint housing 440 used to liquefy the filler 255. Suitable materials include polymers, a silicon material, rubber, a Teflon® material, among others. The retention member 415 may be applied as needed when the joint housing 440 and/or the filler 255 is heated, and removed after adjustment of the connecting member 125 and solidification of the filler 255. Alternatively, the retention member 415 may be a permanent element of the adjustable joint 250. The retention member 418 may include an elastic neck 428 and a flexible junction 430 joined with a compliant skirt 426. The elastic junction 430 may include an inwardly extending lip 432 adapted to seat in a groove 434 formed in the joint housing 440, which may enhance sealing and coupling between the joint housing 440 and the retention member 418.

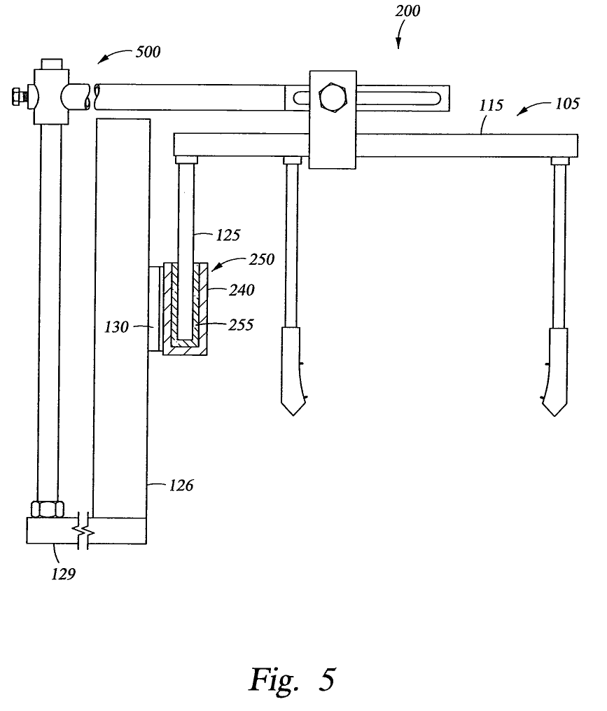

FIG. 5 is a schematic view of one embodiment of a holding means 500 coupled to a transfer mechanism 200 to facilitate adjustment of the transfer means 105 relative to the translational means 110. The holding means may be a clamp, shims, blocks, locating pins, spacers, a magnetic device, or any device or article capable of restricting the transfer means 105 relative to the translational device 110 and/or the base 129. In some applications, the holding means 500 may be a real or dummy workpiece that is positioned or otherwise held in a position relative to the transfer mechanism 105 (or other device to be positioned).

In operation, the filler 255 is heated by a heat source, such as by the heating members 330, 345 (FIGS. 3A and 3B) or other suitable heating means, to at or near a melt-point as described above, which allows movement and manipulation of the transfer means 105 relative to the translational means 110. Specifically, the filler 255 is heated to allow movement between the connecting member 125 and the joint housing 240. The heat provided from the heating members 330 and/or 345 to the filler 255, may be a temperature at or near the melt-point or melt-point range of the filler 255, or a temperature above the melt-point or melt-point range of the filler 255.

Once the filler 255 is heated to at or near the melt-point or melt-point range of the filler, power to the heating members 330, 345 may be maintained, lowered, or turned off, depending on the heat initially provided and/or the adjustment time. As the filler 255 is in this non-solid phase, the transfer means 105 may be positioned and aligned as needed with or without the continued energy from the heating members 330, 345. Once the adjustment and/or alignment is made, any power supplied by the heating members 330, 345 is halted, and the holding means 500 is used to restrict movement during cooling and solidification of the filler 255, which requires the filler 255 temperature to be below the melt-point or melt-point range. This cooling period may be a relatively short or long period depending on the temperature of the filler 255, the mass of the filler 255, and/or the mass or construction of the joint housing 240, but the period may be shortened by cooling the filler with a fluid or other cooling means. Once the filler 255 is solidified, the holding means 500 may be removed and the transfer mechanism 200 may be put into service.

In the exemplary embodiments depicted and described herein, the adjustable joint 250 may comprise a process kit or replacement part that may replace the existing joints or interfaces between two or more structures, devices, or mechanisms. For example, an existing joint, such as the joint 150 of FIG. 1 may be replaced with the adjustable joint 250 by decoupling the junction 140 from the extended member 130 and replaced by coupling a joint housing, such as joint housings 240, 340, or 440, to the extended member 130. The process kit may include a joint housing 240, 340, or 440, a heating means, retention members sized or adaptable to the connecting member 125, and the filler 255.

Embodiments of an adjustable joint 250 as described herein meets or exceeds some of the challenges faced when adjusting or aligning one element relative to another element on a piece of equipment. For example, the adjustable joint 250 includes no screws to tighten or adjust, which may significantly reduce downtime if access to the joint is restricted. The filler 255 allows six degrees of freedom when in a viscid, semi-viscid, or liquefied state and once the filler 255 has solidified, there is no tendency for one adjustment to affect another adjustment as described in reference to the adjustment members 135 of FIG. 1, which also reduces downtime by personnel. The filler 255 may be re-heated and reused multiple times and is not consumed. The filler 255 that has been tested provides good mechanical strength having a tensile strength of about 5000 psi to about 7000 psi, which is sufficient for the device the filler was tested on. The filler also demonstrated suitable compressive strength and other physical properties for the application. During testing, adjustment time of the device was significantly reduced, and cooling of the filler took about two minutes, which provided a significantly reduced alignment/adjustment time, which significantly decreased down time of the device.

While the foregoing is directed to embodiments of the present invention, other and further embodiments of the invention may be devised without departing from the basic scope thereof, and the scope thereof is determined by the claims that follow.

1. An adjustable joint, comprising:
a housing having an interior volume configured to receive at least a portion of a shaft;
a heating means coupled to and in communication with at least a portion of the housing; and
a eutectic filler material disposed in the housing that is cycled between a solid state and a liquid state, wherein the filler material has a melt-point range between about 110° F. and about 160° F.

2. The adjustable joint of claim 1, wherein the heating means is selected from the group consisting of a cartridge heater, heating tape, heating coils, or combinations thereof.

3. The adjustable joint of claim 1, wherein the housing comprises a tubular shape.

4. The adjustable joint of claim 1, wherein the housing comprises a bottom.

5. The adjustable joint of claim 1, wherein the interior volume includes a longitudinal passage.

6. The adjustable joint of claim 1, wherein the filler is in a liquid state at 136° F. and in a solid state at 135° F.

7. The adjustable joint of claim 1, wherein the heating means is disposed within the housing.

8. The adjustable joint of claim 1, wherein the interior volume is dimensioned about 50% to about 100% greater than a cross-sectional dimension of the shaft.

9. The adjustable joint of claim 1, wherein the housing further comprises:
at least one flexible retention member disposed on the housing.

10. An adjustable interface between two or more structural components disposed on a piece of equipment, comprising:
a shaft coupled to at least one of the structural components;
a housing having an interior volume configured to receive at least a portion of the shaft, the interior volume sized to permit axial, radial, rotational, and longitudinal movement to the shaft;
a filler material disposed in the interior volume and in contact with the portion of the shaft disposed in the interior volume; and
a flexible retention member coupled to a portion of the housing and the shaft, wherein the housing is configured to provide heat to the filler material.

11. The adjustable interface of claim 10, wherein the filler material has a melting point of about 136° F. or less.

12. The adjustable interface of claim 10, wherein the housing includes a heating means coupled thereto.

13. The adjustable interface of claim 10, wherein the housing includes a heating means coupled to a power source.

14. The adjustable interface of claim 10, wherein the filler material is selected from the group consisting of metals, polymers, a reinforced wax composite, and combinations thereof.

15. A method for adjusting an interface between two or more structural components disposed on a piece of equipment, comprising:
providing a housing at the interface having an interior volume configured to receive at least a portion of one of the two or more structural components, wherein the structural component is in communication with a solid filler material disposed in the housing;
heating the solid filler material to at or near a melt-point;
adjusting the structural component in one or more of the six degrees of freedom; and
cooling the filler material below the melt-point.

16. The method of claim 15, wherein the melt-point is in a range between about 160° F. and about 115° F.

17. The method of claim 15, wherein the filler material is a non-eutectic material.

18. The method of claim 15, wherein the filler material is a eutectic material.

19. The method of claim 15, wherein the filler material is a thermoplastic.

20. The method of claim 15, further comprising:
re-heating the solid filler material to the melt-point; and
re-adjusting the structural component in one or more of the six degrees of freedom.

21. A method for adjusting an interface between a first and second structural component, comprising:
providing a housing at the interface having an interior volume configured to receive at least a portion of the first structural component and having a metallic filler material disposed therein; and
cycling the metallic filler material between a liquid state and a solid state, wherein the first structural component may be moved relative to the second structural component when the filler is in a viscid, semi-viscid, or liquid state, and wherein the first structural component is fixed relative to the second structural component when the filler is in a solid state.

22. The method of claim 21, wherein the metallic filler material is a eutectic material.

23. The method of claim 21, wherein the metallic filler material is a non-eutectic material.
